(19) United States
(12) Patent Application Publication
(10) Pub. No.: US 2022/0176798 A1
(43) Pub. Date: Jun. 9, 2022

(54) Hybrid Transmission Assembly, Motor Vehicle Powertrain, and Motor Vehicle

(71) Applicant: ZF Friedrichshafen AG, Friedrichshafen (DE)

(72) Inventors: Stefan Beck, Eriskirch (DE); Matthias Horn, Tettnang (DE); Johannes Kaltenbach, Friedrichshafen (DE); Fabian Kutter, Kressbronn (DE); Michael Wechs, Weißensberg (DE); Thomas Martin, Weissensberg (DE); Martin Brehmer, Tettnang (DE); Peter Ziemer, Tettnang (DE); Oliver Bayer, Hörbranz (AT); Thomas Kroh, Lindau (DE); Max Bachmann, Friedrichshafen (DE)

(21) Appl. No.: 17/436,279

(22) PCT Filed: Oct. 15, 2019
(86) PCT No.: PCT/EP2019/077972

§ 371 Date: Sep. 3, 2021

(30) Foreign Application Priority Data
Mar. 5, 2019 (DE) 10 2019 202 963.9

(51) Int. Cl. B60K 6/40; B60K 6/44; B60K 6/387; F16H 3/091; B60K 6/547

(52) U.S. Cl. CPC B60K 6/40; B60K 6/44; B60K 6/387; F16H 2200/0069; B60K 6/547; F16H 2200/0047; B60Y 2200/92; F16H 3/091

(57) ABSTRACT

A hybrid transmission assembly for a motor vehicle powertrain may include an input shaft arrangement including a first input shaft of a first sub-transmission and a second input shaft of a second sub-transmission. The assembly may further include a first electric machine axially parallel and connected to the first input shaft, and a second electric machine axially parallel and connected to the second input shaft. The input shaft arrangement, viewed axially, is in a center of four quadrants. An axis of the first electric machine is in the first quadrant and, or alternatively, an axis of the second electric machine is in the fourth quadrant.

### CROSS-REFERENCE TO RELATED APPLICATION

The present application is related and has right of priority to German Patent Application No. 10 2019 202 963.9 filed on Mar. 5, 2019 and is a nationalization of PCT/EP2019/077972 filed in the European Patent Office on Oct. 15, 2019, both of which are incorporated by reference in their entirety for all purposes.

### FIELD OF THE INVENTION

The present invention relates generally to a hybrid transmission assembly for a motor vehicle drive train or powertrain, having an input shaft arrangement, which includes a first input shaft of a first sub-transmission and a second input shaft of a second sub-transmission, having a first electric machine connected to the first input shaft and arranged axially parallel thereto, and having a second electric machine connected to the second input shaft and arranged axially parallel thereto.

The present invention further relates generally to a hybrid powertrain with a dual-clutch assembly having a first clutch and a second clutch, which include a shared input element connectable to an internal combustion engine, wherein the first clutch includes a first output element, and wherein the second clutch includes a second output element. The hybrid powertrain further including a hybrid transmission assembly of the aforementioned type, wherein the first input shaft is connected to the first output element, and wherein the second input shaft of the second sub-transmission is connected to the second output element.

Finally, the present invention relates generally to a motor vehicle with a hybrid transmission assembly of the aforementioned type or with a hybrid drive train of the aforementioned type, wherein the transmission assembly or arrangement is aligned transversely to a longitudinal axis of the motor vehicle.

### BACKGROUND

A transmission arrangement of the above-described type is known from document DE 10 2006 036 758 A1. The automated dual-clutch transmission disclosed therein includes two input shafts and at least one output shaft and an unsynchronized gear clutch, wherein associated with each of the input shafts is a separate motor/engine clutch for connection to the drive shaft of a prime mover and, for connection to the output shaft, a group of gear-step gearwheels, in each case, having different ratios and each including one fixed gear and one idler gear engageable by an associated gear clutch. In order to simplify the configuration and the controllability, the two engine clutches are unsynchronized dog clutches. Two electric machines, which are alternately drivingly connected to one of the input shafts, are provided as starting and synchronizing means.

Dual-clutch transmissions have represented an alternative to torque converter automatic transmissions for several years. Dual-clutch transmissions have a dual-clutch assembly, which is connectable on the input side to a prime mover such as an internal combustion engine. An output element of a first friction clutch of the clutch assembly is connected to a first input shaft of a first sub-transmission, which is typically associated with the even forward gear steps or with the odd forward gear steps. An output element of a second friction clutch of the dual-clutch assembly is connected to a second input shaft of a second sub-transmission, which is typically associated with the other forward gear steps.

The gear steps associated with the sub-transmissions are generally engaged and disengaged in an automated manner. During normal operation, one of the clutches of the dual-clutch assembly is engaged. In the other, inactive, sub-transmission, a connecting gear step is then engaged in advance. A gear change is then carried out essentially without interruption of tractive force by an overlapping actuation of the two friction clutches.

Motor vehicle transmissions are generally for either the front or the rear transverse installation in a motor vehicle, wherein attention is paid, in particular, to a short axial installation length. Alternatively, transmissions for a longitudinal installation in a motor vehicle, wherein attention is paid, in particular, to a radially compact design.

In the front-mounted and rear-mounted transverse transmissions, two countershafts arranged axially parallel are frequently associated with an input shaft arrangement, and so the power flow takes place from the input shaft arrangement either via the one countershaft or via the other countershaft. The countershafts are also output shafts and, in general, are both in engagement with a differential for distributing input power to driven wheels.

A further trend in the field of motor vehicle drive trains is so-called “hybridization.” In general, this means a prime mover in the form of an internal combustion engine has associated therewith an electric machine, as a further prime mover. Here, a distinction is made between a plurality of different concepts, which each provide a different connection of the electric machine to the transmission. In a typical variant of dual-clutch transmissions, an electric machine is arranged concentrically to an input element of the dual-clutch assembly. In order to be able to utilize the electric machine, in this case, not only for assisting the internal combustion engine, but rather also to be able to set up a purely electric motor-driven operation, the input element of the dual-clutch assembly is generally connected to the internal combustion engine by a separating clutch or an internal combustion engine-decoupling device.

In the dual-clutch transmission described in DE 10 2006 036 758 A1 mentioned at the outset, an electric machine is associated with each sub-transmission. Moreover, the dual-clutch assembly is formed by two unsynchronized dog clutches. The rotational-speed adaptations necessary for pulling away from rest and for the synchronization during gear changes are implemented by the electric machines. The unsynchronized dog clutches are combined in a shared clutch block, which has two engagement positions, in which one of the two clutches is engaged in each case, and a neutral position with a completely interrupted power flow. During gear changes in an internal combustion engine-driven operation, a changeover of the clutches of the dual-clutch assembly is always necessary. Moreover, depending on the type of the gear change, one or both electric machine(s) must be actuated for the synchronization and/or for the load transfer. Moreover, the internal combustion engine must always self-synchronize during these types of gear changes.

The hybridization of transmissions, with respect to the requirements mentioned at the outset, places high requirements on radial and/or axial installation space.

### SUMMARY OF THE INVENTION

Example aspects of the present invention provide an improved hybrid transmission arrangement, an improved hybrid drive train, and an improved motor vehicle.

Example aspects of the present invention provide, on the one hand, a hybrid transmission assembly for a motor vehicle drive train, with an input shaft arrangement or assembly, which includes a first input shaft of a first sub-transmission and a second input shaft of a second sub-transmission, with a first electric machine connected to the first input shaft and arranged axially parallel thereto, with a second electric machine connected to the second input shaft and arranged axially parallel thereto. The input shaft arrangement, as viewed axially, is arranged in a center of four quadrants, of which a first quadrant is situated above the input shaft arrangement and on a first longitudinal side of the input shaft arrangement, of which a second quadrant is situated below the input shaft arrangement and on the first longitudinal side of the input shaft arrangement, of which a third quadrant is situated below the input shaft arrangement and on a second longitudinal side of the input shaft arrangement, and of which a fourth quadrant is situated above the input shaft arrangement and on the second longitudinal side of the input shaft arrangement. An axis of the first electric machine is arranged in the first quadrant and/or an axis of the second electric machine is arranged in the fourth quadrant.

Moreover, example aspects of the present invention provide a hybrid drive train with a dual-clutch assembly, which has a first clutch and a second clutch, which include a shared input element connectable to an internal combustion engine. The first clutch includes a first output element, and the second clutch includes a second output element. The hybrid drive train further includes a hybrid transmission arrangement of the type according to example aspects of the invention, wherein the first input shaft is connected to the first output element, and wherein the second input shaft of the second sub-transmission is connected to the second output element.

Finally, example aspects of the present invention provide a motor vehicle with a hybrid transmission arrangement of the type according to the example aspects of invention or with a hybrid drive train of the type according to example aspects of the invention, wherein the transmission arrangement is aligned transversely to a longitudinal axis of the motor vehicle and is installed in the motor vehicle at the front in order to drive front wheels or at the rear in order to drive rear wheels.

Due to the measure of arranging the first electric machine in the first quadrant and the second electric machine in the fourth quadrant, a hybrid transmission arrangement is compact, in particular, in the vertical direction.

Preferably, the first electric machine is arranged entirely in the first quadrant. Preferably, the second electric machine is arranged entirely in the fourth quadrant.

The terms “above” and “below” utilized above preferably relate to a vertical gravitational direction. The first longitudinal side of the input shaft arrangement is preferably a longitudinal side of the input shaft arrangement situated at the rear in the forward direction of travel of the motor vehicle. The second longitudinal side is preferably situated ahead of the first longitudinal side in the forward direction of travel of a motor vehicle (in the installed condition of the hybrid transmission arrangement).

A method for operating a hybrid drive train of the type according to example aspects of the invention includes, in a purely electric motor-driven operation, providing input power of the first electric machine via the first sub-transmission and simultaneously providing input power of the second electric machine via the second sub-transmission, wherein a powershift is implemented where one of the electric machines maintains the tractive force via the associated sub-transmission, while a gear change is carried out in the other sub-transmission.

In addition, both electric machines are utilized as a generator or as a motor in a serial operation. In the present case, a serial operation is understood to mean that, in a purely electric motor-driven operation by one of the two electric machines, the other electric machine is simultaneously driven by the internal combustion engine and operated as a generator in order to charge a vehicle battery. The vehicle battery is preferably the same battery from which the electric machine operating as a motor withdraws power.

In addition, with the hybrid drive train according to example aspects of the invention, it is possible to utilize an electric machine for synchronization during gear changes in an internal combustion engine-driven operation or a hybrid operation, i.e., to assist the internal combustion engine during synchronization by or with an electric machine. In other words, in the internal combustion engine-driven operation or in the hybrid operation, one of the electric machines is always connected to the internal combustion engine. As a result, a load-point displacement at the internal combustion engine is possible and this electric machine assists during the closed-loop control of the rotational speed when a shift element, such as a gearshift clutch, must be synchronized. Consequently, the internal combustion engine does not need to synchronize “on its own”, but rather is always “picked up” at the current rotational speed of the internal combustion engine by one of the two electric machines.

In the transmission arrangement, the first input shaft and the second input shaft are preferably arranged coaxially to each other. The first input shaft is preferably an inner shaft. The second input shaft is preferably a hollow shaft. The transmission arrangement preferably includes precisely one countershaft. Preferably, the one countershaft is simultaneously an output shaft of the transmission arrangement. For this purpose, the countershaft is preferably connected to an output gear for driving a power distribution arrangement, such as a differential.

Engageable gear sets are understood to be, in the present case, gear sets that include an idler gear and a fixed gear, which are in engagement with each other in an intermeshed manner, and which are engageable by an associated gearshift clutch. In an engaged gear set, the idler gear of this gear set is rotationally fixed to the associated shaft. The gear sets are preferably spur gear trains, which preferably connect one of the two input shafts and the countershaft to each other, in each case.

A regular forward gear step, i.e., a fixed ratio, is preferably associated with each gear set. The transmission arrangement preferably does not include a gear set, with which a reverse gear step is associated. Travel in reverse is preferably implemented exclusively via one of the electric machines.

In the present case, power is preferably always transmitted only via one gear set either from the first input shaft to the countershaft or from the second input shaft to the countershaft, and so the spread of gear ratios of the transmission arrangement results preferably exclusively due to the ratios of the regular forward gear steps. Consequently, the transmission arrangement generally operates with a high efficiency.

In one preferred embodiment, the first sub-transmission is associated with the odd gear steps. In a corresponding way, the second sub-transmission in one preferred embodiment is associated with the even forward gear steps.

In the present case, a connection is understood to mean, in particular, that the two elements to be connected to each other are permanently connected to each other in a rotationally fixed manner. Alternatively, however, the two elements are connected to each other in a rotationally fixed manner as necessary. In the present case, a rotationally fixed connection is understood to mean that the elements connected in this way rotate at a rotational speed proportional to each other, in particular at the same rotational speed.

The electric machines are preferably arranged axially parallel to the transmission arrangement. Consequently, the longitudinal axes of the electric machines are preferably arranged in parallel, although offset with respect to the input shafts as well as to the countershaft.

A third clutch preferably connects the first input shaft and the second input shaft. The third clutch is preferably not a clutch of the type that is utilized for establishing a so-called “winding-path gear step” in the transmission arrangement. This is the case because, during the establishment of a winding-path gear step, two gear sets of each of the two sub-transmissions are generally involved in order to implement a ratio that is as low as possible or a ratio that is as high as possible, i.e., in order to allow for a high spread of gear ratios of the transmission arrangement.

In the hybrid drive train, which preferably includes the third clutch, a method for operating same includes, during an internal combustion engine-driven operation or a hybrid operation, utilizing the gear steps of the one sub-transmission by engaging the associated clutch of the dual-clutch assembly and of utilizing the gear steps of the other sub-transmission by engaging the same clutch and the third clutch.

With a hybrid drive train of this type, a method is also be carried out, including, in an internal combustion engine-driven operation, disengaging the third clutch in a gear step of the one sub-transmission in order to decouple the other sub-transmission and the electric machine associated with the other sub-transmission.

The hybrid drive train according to example aspects of the invention makes it possible, due to the preferred provision of the third clutch for connecting the first sub-transmission and the second sub-transmission, for gear changes to be carried out in an internal combustion engine-driven operation or in a hybrid operation without the need to actuate the dual-clutch assembly. Moreover, since a separate electric machine is associated with each sub-transmission, both electric machines are provided for making input power available.

In the internal combustion engine-driven operation or in the hybrid operation, upon implementation of one embodiment of a method by the preferred hybrid drive train, which includes the third clutch, the one clutch of the one sub-transmission remains engaged for all conditions of this operation, while the other clutch of the dual-clutch assembly remains disengaged during all conditions of this operation.

In a purely electric motor-driven operation, it is possible with the preferred hybrid drive train to disengage both clutches of the dual-clutch assembly and to engage the third clutch, and the two electric machines are coupled to each other and, jointly, provide input power via a single gear step. Alternatively, it is possible, in a purely electric motor-driven operation, to operate the two electric machines in parallel via the respective particular sub-transmissions and leave the third clutch disengaged.

The second clutch of the dual-clutch assembly, which is preferably always disengaged in the normal internal combustion engine-driven operation and in the normal hybrid operation, is preferably engaged during the serial operation. In the serial operation, one electric machine operates as a motor and provides electric motor-generated power for a purely electric motor-driven operation, for example, for an operation in a starting gear step (first gear), in order to drive a vehicle in a so-called “crawler gear”. In a crawler gear of this type, the ground speed of the vehicle is generally below a speed, at which the internal combustion engine is utilized as a prime mover (due to the ratio of the lowest gear step or starting gear step). In order to also be able to permanently establish a low ground speed of this type beyond the maximum capacity of the vehicle battery, the above-described serial operation is implemented.

In one preferred variant, the order of the elements starting from an input of the transmission arrangement is as follows: gear set for the fourth forward gear step, gearshift clutch assembly for the second and fourth forward gear steps, gear set for the second forward gear step, gearshift clutch assembly with a gearshift clutch for the third forward gear step (or the fifth forward gear step) and, preferably, with the third clutch, gear set for the third forward gear step (or the fifth forward gear step), gear set for the first forward gear step, gearshift clutch assembly for the first and fifth forward gear steps (or the first and third forward gear steps), and gear set for the fifth forward gear step (or the third forward gear step).

The gearshift clutch assemblies for the second and fourth forward gear steps as well as the first and third forward gear steps (or the first and fifth forward gear steps) are preferably arranged at a countershaft. A gearshift clutch assembly, which includes a gearshift clutch for the third or fifth forward gear step and, preferably, the third clutch, is preferably arranged coaxially to the input shafts.

According to one preferred example embodiment, a control device is configured for establishing at least the following operating modes:
a purely internal combustion engine-driven operation,
a purely electric operation by the first electric machine, and
a purely electric operation by the second electric machine.

Moreover, the control device is configured for establishing a hybrid operation, in which input power is provided by the internal combustion engine and electric motor-generated input power is provided by the first electric machine and/or the second electric machine. The hybrid traveling mode is a drive mode, although the hybrid travelling mode is also a mode in which mechanical input power is at least partially supplied to the electric machines in order to operate the electric machines as generators for charging a vehicle battery.

Moreover, the hybrid drive train is preferably configured for carrying out a so-called “sailing operation,” in which, starting from a moderate or high ground speed, the internal combustion engine is decoupled and the ground speed is maintained, for example, by an intermittent operation of one or both electric machine(s). Stationary charging is also possible.

As mentioned, a so-called “crawling mode” is also possible, in particular for the case in which a serial operation is established, as defined above. Consequently, the hybrid drive train is operable in all conceivable electric motor-driven, internal combustion engine-driven, or hybrid traveling modes.

According to one preferred example embodiment, the third clutch and a gearshift clutch for engaging a gear set of a sub-transmission are accommodated in a gearshift clutch assembly.

In general, a gearshift clutch assembly is understood to be an arrangement formed from two gearshift clutches, which are alternately actuatable by one single actuating unit. Moreover, a gearshift clutch assembly generally has a neutral position, in which neither of the two gearshift clutches of the assembly is engaged. A gearshift clutch assembly of this type is also referred to as a “double shift element.”

It is particularly preferred when the gear set that is engageable by the gearshift clutch assembly is associated with the sub-transmission, the associated clutch of which is always engaged in the internal combustion engine-driven operation and in the hybrid operation. Preferably, the gear set that is engageable by the gearshift clutch assembly is associated with the first sub-transmission, which is associated with the odd forward gear steps. It is particularly preferred when the gear set is associated with the fifth forward gear step or the third forward gear step.

Preferably, the hybrid transmission arrangement includes a countershaft, wherein the first input shaft and the second input shaft are both connected to the countershaft via at least one engageable gear set, wherein the countershaft is connected, via an output gear set, to a power distribution unit, such as a differential.

As a result, a radially compact design is implemented since the transmission arrangement preferably includes only one single countershaft.

It is particularly preferred when an axis of the power distribution unit is arranged in the second quadrant and/or when an axis of the countershaft is arranged in the second quadrant and/or when the axis of the countershaft is arranged closer to the third quadrant than the axis of the power distribution unit.

Due to this measure as well, a radially and vertically compact hybrid transmission arrangement is provided, which preferably still has a low center of gravity.

The axis of the power distribution unit is preferably coaxial to driven wheels of the motor vehicle.

The power distribution unit is either arranged completely within the second quadrant or also at least partially extends into the first quadrant.

The countershaft with the gearwheels arranged thereon is predominantly arranged in the second quadrant, although it can also partially extend into the third quadrant, preferably, however, not into the first quadrant or into the fourth quadrant.

According to one further preferred embodiment, axially displaceable actuating units for engaging engageable gear sets and/or for actuating a dual-clutch assembly associated with the hybrid transmission arrangement and/or for actuating a third clutch of the hybrid transmission arrangement are arranged in the third quadrant.

This also contributes to a radially and vertically compact design.

In a further embodiment preferred overall, the first electric machine is connected to the first input shaft via an engageable gear set or gear-step gear set of the first sub-transmission and/or the second electric machine is connected to the second input shaft via a gear-step gear set of the second sub-transmission.

In general, it is conceivable to arrange the electric machines coaxially to, for example, the particular input shaft of the sub-transmissions. It is preferred, however, when the electric machines are arranged axially parallel to the input shaft arrangement. The connection to the particular input shaft then takes place via a flexible traction drive mechanism or a gear set. A separate gear set is provided for this purpose. This has the advantage of a connection having an optimized ratio. As mentioned above, it is preferred, however, when the connection of the electric machines takes place via particular gear-step gear sets. Weight is saved as a result. A ratio adaptation preferably takes place as a machine pinion of the particular electric machine is not directly connected to a gearwheel of the gear-step gear set or is in engagement therewith in an intermeshed manner, but rather that an intermediate gear is intermediately connected, so the electric machines are connected to the particular sub-transmissions with an optimized ratio. In particular, the electric machines are implemented as relatively high-speed machines, which are compact.

It is particularly preferred when the gear-step gear set of the first sub-transmission, via which the first electric machine is connected to the first input shaft, is associated with the highest gear step of the first sub-transmission, and/or when the gear-step gear set of the second sub-transmission, via which the second electric machine is connected to the second input shaft, is associated with the highest gear step of the second sub-transmission.

According to one further preferred, example embodiment, the gear-step gear set of the first sub-transmission, via which the first electric machine is connected to the first input shaft, is arranged at a first axial end of the transmission arrangement, and/or the gear-step gear set of the second sub-transmission, via which the second electric machine is connected to the second input shaft, is arranged at a second axial end of the transmission arrangement.

This allows for a connection of the electric machine, on the one hand, at the points, at which high bearing forces are absorbed, since housing walls or bearing plates are generally arranged at the axial ends of the transmission arrangement. Moreover, this allows for a connection of the electric machines in such a way that these connections remain as unaffected as possible from each other. In addition, this type of connection makes it possible for the electric machines to be arranged in axial overlap with each other. It is particularly preferred when the first electric machine and/or the second electric machine extend(s) between the first axial end of the transmission arrangement and the second axial end of the transmission arrangement. As a result, an axially compact design is also implemented.

According to one further example embodiment preferred overall, which represents a separate example aspect of the invention, the first electric machine is connected, via a first intermediate gear, to a first gearwheel arranged at the first input shaft and/or the second electric machine is connected, via a second intermediate gear, to a second gearwheel arranged at the second input shaft.

The first gearwheel and the second gearwheel are gearwheels of engageable gear sets, as described above. The first gearwheel and the second gearwheel are also connected to the particular input shaft in a rotationally fixed, in particular, fixed manner, however.

Provided that the one electric machine or both electric machines is/are connected at a gear-step gear set, this preferably takes place via a particular fixed gear, which is fixedly connected to the particular input shaft.

According to one further example embodiment preferred overall, the first sub-transmission is associated with the odd forward gear steps and includes three gear sets, which are associated with different forward gear steps, and/or the second sub-transmission is preferably associated with the even forward gear steps and includes two or three gear sets, which are associated with different forward gear steps.

By five or six forward gear steps, an internal combustion engine-driven operation across a large speed range is implemented. For very low speed ranges, travel takes place exclusively by electric motor, if necessary.

The transmission arrangement therefore preferably has only five or six gear set planes. Moreover, the transmission arrangement preferably has only three gearshift clutch planes, in each of which preferably precisely one gearshift clutch assembly is arranged.

Preferably, the transmission arrangement includes only precisely four actuating units, three of which are associated with the gearshift clutch assemblies of the transmission arrangement and one of which is associated with the dual-clutch assembly.

According to one further embodiment preferred overall, the first electric machine and the second electric machine are identical.

This yields cost advantages and stock-control advantages. The two electric machines then operate practically “equally” within the transmission arrangement and are both operated alternately as a prime mover for driving a motor vehicle and/or as a generator for charging a vehicle battery.

As described above, it is preferred when a third clutch is provided for connecting the first sub-transmission and the second sub-transmission, and when the third clutch and a gearshift clutch for engaging a gear set of a sub-transmission form a gearshift clutch assembly.

According to one further preferred embodiment, the first clutch of the dual-clutch assembly and/or the second clutch of the dual-clutch assembly and/or the third clutch and/or at least one gearshift clutch of the transmission arrangement are/is a dog clutch, i.e., as a non-synchronized shift element. A dog clutch of this type includes, in particular, no friction elements for synchronizing components to be connected to each other.

Due to the fact that a separate electric machine is associated with each sub-transmission, functions of the synchronization and/or of the load transfer takes place by the electric machines. Accordingly, the above-mentioned clutches are dog clutches, and so potential for the reduction of the axial and/or radial installation space results, as well as weight advantages.

The two clutches of the dual-clutch assembly are actuated independently of each other by separate actuating units. It is particularly preferred, however, when the first clutch and the second clutch of the dual-clutch assembly are accommodated in a gearshift clutch assembly, which is actuated by a single actuating unit. Consequently, the gearshift clutch assembly has a first position, in which the first clutch is engaged, a second position, in which the second clutch is engaged, and a third position, in which neither the first clutch nor the second clutch is engaged, i.e., a neutral position.

In general, both clutches of the dual-clutch assembly are dog clutches or both are friction clutches. It is preferred when the first clutch of the dual-clutch assembly is a friction clutch and when the second clutch of the dual-clutch assembly is a form-locking dog clutch.

This embodiment is advantageous, in particular, for the case in which the above-described third clutch is for connecting the first input shaft and the second input shaft.

Thereupon, namely, an internal combustion engine-driven operation and a hybrid operation are established exclusively via the first clutch. In an emergency situation, the first clutch is then easily disengaged under load, which provides safety-related advantages.

The second clutch, in this embodiment, is generally disengaged and, for example, is engaged only in a serial operation and, therefore, is a form-locking dog clutch, since a disengagement under load is not necessary.

Overall, by the hybrid drive train, depending on the embodiment, at least one of the following advantages is achieved:
low design complexity, since preferably only five (if necessary, six) gear set pairs and four actuating units are to be provided,
good efficiency and a simple configuration result, since, in particular, no winding-path gear steps are implemented,
low component loads result,
at least three electric gear steps result for the first electric machine and at least two gear steps result for the second electric machine,
the transmission arrangement includes preferably only one countershaft, which is preferably connected to a power distribution unit via only one output gear set,
gear change operations are carried out quickly and efficiently, since an engagement of the dual-clutch assembly is not necessary in an internal combustion engine-driven operation and a hybrid operation and since the synchronization of gear steps is always implementable also by utilizing an electric machine,
a serial operation is implementable by the first electric machine and also by the second electric machine as a generator,
high versatility in combination with compact dimensions.

It is particularly preferred when an internal combustion engine-driven operation and a hybrid operation are established in such a way that one of the two clutches of the dual-clutch assembly is always engaged and the other clutch always remains disengaged (depending on the gear step, the preferred third clutch is disengaged or engaged).

It is understood that the features, which are mentioned above and which will be described in greater detail in the following, are usable not only in the particular combination indicated, but also in other combinations or alone, without departing from the scope of the present invention.

### BRIEF DESCRIPTION OF THE DRAWINGS

Exemplary embodiments of the invention are represented in the drawing and are explained in greater detail in the following description, wherein

FIG. 1 shows a diagrammatic gear set representation of an embodiment of a hybrid drive train;

FIG. 2 shows a diagrammatic power flow representation of a further embodiment of a hybrid drive train;

FIG. 3 shows a schematic of a further embodiment of a hybrid drive train;

FIG. 4 shows an alternative embodiment of a dual-clutch assembly;

FIG. 5 shows a gearshift table for an internal combustion engine-driven operation and a hybrid operation of the hybrid drive train from FIG. 1;

FIG. 6 shows a gearshift table for an electric motor-driven operation by the first electric machine;

FIG. 7 shows a gearshift table for an electric motor-driven operation by the second electric machine;

FIG. 8 shows an axial view of a preferred embodiment of a hybrid drive train with four quadrants represented; and

FIG. 9 is a lateral representation of a motor vehicle, in which the four quadrants from FIG. 8 are indicated either in the area of a front or of a rear of the motor vehicle, in order to visualize the particular installation position.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

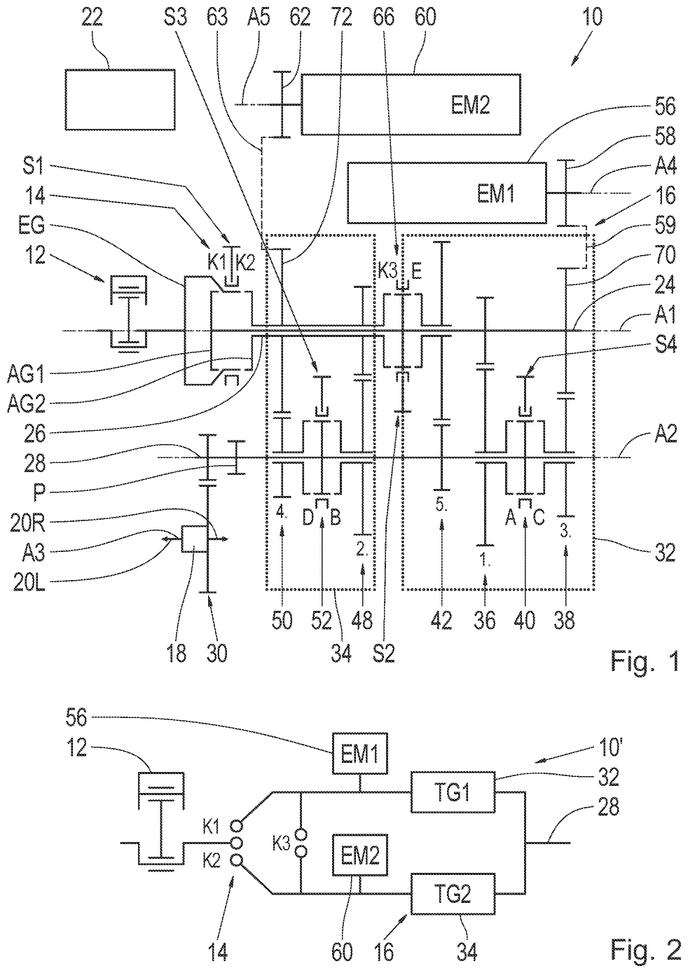

In FIG. 1, a hybrid drive train 10 for a motor vehicle, in particular a passenger car, is represented in diagrammatic form.

The hybrid drive train 10 includes an internal combustion engine 12, which is connected to an input element of a dual-clutch assembly 14. The dual-clutch assembly 14 is connected on the output side to a hybrid transmission arrangement 16. An output of the hybrid transmission arrangement 16 is connected to a power distribution unit 18, which is, for example, a mechanical differential for distributing the input power to two driven wheels 20L, 20R of the motor vehicle.

Moreover, the hybrid drive train 10 includes a control device 22 for controlling all components thereof.

The dual-clutch assembly 14 is arranged on a first axis A1, which is coaxial to a crankshaft of the internal combustion engine 12. The dual-clutch assembly 14 includes two friction clutches or one friction clutch and a non-synchronized dog clutch. In the present case, the dual-clutch assembly 14 includes two non-synchronized dog clutches, including a first clutch K1 and a second clutch K2. The two clutches K1, K2 have a shared input element EG, which is rotationally fixed to the crankshaft of the internal combustion engine 12. The first clutch K1 has a first output element AG1. The second clutch K2 has a second output element AG2. The output elements AG1, AG2 are arranged coaxially to each other.

The transmission arrangement 16 includes a first input shaft 24 and a second input shaft 26. The input shafts 24, 26 are arranged coaxially to each other and to the first axis A1. The first input shaft 24 is an inner shaft. The second input shaft 26 is a hollow shaft.

Moreover, the transmission arrangement 16 includes a countershaft 28, which is an output shaft 28 and is arranged coaxially to a second axis A2. The output shaft 28 is connected via an output gear set 30 to the power distribution unit 18, which is arranged coaxially to a third axis A3.

A parking interlock gear is fixed at the output shaft 28 or at an input element of the power distribution unit 18 in a rotationally fixed manner, by which the hybrid drive train 10 is immobilized. The associated parking lock device is not represented, for the sake of clarity.

The transmission arrangement 16 has a first sub-transmission 32 and a second sub-transmission 34. The sub-transmissions 32, 34 are arranged axially offset with respect to each other. The first sub-transmission 32 is arranged adjacent to a first axial end of the transmission arrangement 16. The second sub-transmission 34 is arranged adjacent to a second axial end of the transmission arrangement 16, wherein the second axial end is adjacent to the dual-clutch assembly 14. The sub-transmissions 32, 34 have a plurality of engageable gear sets, which, in the engaged condition, connect an input shaft and the output shaft 28 in each case.

The first sub-transmission 32 has a first gear set 36 for the first forward gear step 1 and a second gear set 38 for the third forward gear step 3. The second gear set 38 is arranged closer to the first axial end of the transmission arrangement 16 than the first gear set 36. A first gearshift clutch assembly 40 is arranged between the first gear set 36 and the second gear set 38 and, in fact, coaxially to the second axis A2. The first gearshift clutch assembly 40 includes a first gearshift clutch A for engaging the first gear set 36 and a second gearshift clutch C for engaging the second gear set 38. The two gearshift clutches A, C are alternately engageable and are non-synchronized dog clutches. The engagement of a gear set includes the rotationally fixed connection of an idler gear of the particular gear set to an associated shaft. In the present case, for example, the first gear set 36 is engaged, in that an idler gear of the first gear set 36, which is rotatably mounted at the output shaft 28, is rotationally fixed to the output shaft 28, in order to bring the first gear set 36 into the power flow in this way.

Moreover, the first sub-transmission 32 has a third gear set 42 for the forward gear step 5. The third gear set 42 is arranged closer to the second axial end of the transmission arrangement 16 than the first gear set 36.

The third gear set 42 is engageable by a gearshift clutch E and has an idler gear, which is rotatably mounted at the first input shaft 24.

The second sub-transmission 34 has a fourth gear set 48 for the second forward gear step 2 and a fifth gear set 50 for the fourth forward gear step 4. The fifth gear set 50 is arranged closer to the second axial end than the fourth gear set 48. A second gearshift clutch assembly 52 is arranged between the gear sets 48, 50 and, in fact, coaxially to the second axis A2. The second gearshift clutch assembly 52 has a gearshift clutch B for engaging the fourth gear set 48 and a gearshift clutch D for engaging the fifth gear set 50. The gearshift clutches B, D are accommodated in the second gearshift clutch assembly 52 in such a way that the gearshift clutches B, D are alternately actuatable.

Consequently, the transmission arrangement 16 has five gear set planes, namely, starting from the second axial end toward the first axial end, in the following order: gear set 50 for the fourth forward gear step 4, gear set 48 for the second forward gear step 2, gear set 42 for the fifth forward gear step 5, gear set 36 for the first forward gear step 1, and gear set 38 for the third forward gear step 3.

Moreover, the hybrid drive train 10 includes a first electric machine 56, which is arranged coaxially to a fourth axis A4. The first electric machine 56 has a first pinion 58, which is rotationally fixed to a rotor of the first electric machine 56 and is coaxial to the fourth axis A4. The first pinion, which is also referred to as the first machine pinion, is connected to a gear-step gear set of the first sub-transmission 32, in the present case to the second gear set 38 for the third forward gear step 3, via a first intermediate gear 59, which is rotatably mounted at an axle (not described in greater detail). More precisely, the first pinion 58 meshes with the first intermediate gear 59, and the first intermediate gear 59 meshes with a fixed gear of the second gear set 38, wherein the fixed gear is rotationally fixed to the first input shaft 24.

Moreover, the hybrid drive train 10 has a second electric machine 60, which is arranged axially parallel to the input shafts 24, 26 and, in fact, coaxially to a fifth axis A5. The second electric machine has a second pinion (second machine pinion) 62, which is arranged coaxially to the fifth axis A5. The second pinion 62 is connected to the second input shaft 26 via a gear-step gear set of the second sub-transmission 34. In the present case, the second pinion 62 is connected to the fifth gear set for the fourth forward gear step 4 via a second intermediate gear 63. More precisely, the second pinion 62 meshes with the second intermediate gear 63, which is rotatably mounted at an axle (not described in greater detail), and the second intermediate gear 63 meshes with a fixed gear of the fifth gear set 50, wherein the fixed gear is rotationally fixed to the second input shaft 26.

The five axes A1, A2, A3, A4, A5 are all aligned in parallel with each other.

The dual-clutch assembly 14 is arranged adjacent to the second axial end of the transmission arrangement 16, as mentioned above. The output gear set 30 is also arranged on the second axial side of the transmission arrangement 16 and is preferably axially aligned with the dual-clutch assembly 14 or is situated approximately in a plane therewith. The parking interlock gear P is fixed at the output shaft 28 between the output gear set 30 and the fifth gear set 50.

In the hybrid drive train 10, the electric machines 56, 60 are each connected to a gear-step gear set of the associated sub-transmission, which is associated with the highest gear step of that sub-transmission. Moreover, the electric machines 56, 60 are each connected via a gear-step gear set to the associated particular sub-transmission, which is preferably arranged adjacent to an axial end of the transmission arrangement. The gear sets are situated at opposite axial ends.

The electric machines 56, 60 are arranged in axial overlap with each other. Due to the connection via intermediate gears 59, 63, high ratios for the particular gear-step gear sets are established, and so relatively high-speed electric machines are utilized, which are compact.

The hybrid transmission arrangement in the present example embodiment has precisely five forward gear steps and does not have a reverse gear step. An operation in reverse is exclusively established by the hybrid drive train 10 when one of the electric machines 56 or 60 is driven in the opposite direction of rotation.

The transmission arrangement 16 has no winding-path gear steps. Each gear set 36, 38, 42, 48, 50 includes precisely one idler gear and one fixed gear, wherein the idler gears of the gear sets 36, 38, 48, 50 are rotatably mounted at the output shaft 28, and wherein the idler gear of the gear set 42 is rotatably mounted at the first input shaft 24.

Moreover, the hybrid drive train 10 includes a third clutch K3, which is also referred to as a bridge clutch.

The third clutch is utilized for connecting the first input shaft 24 and the second input shaft 26. The third clutch K3 is arranged adjacent to the fourth gear set 48 for the second forward gear step 2 and is accommodated, with the gearshift clutch E for the third gear set 42 for engaging the fifth forward gear step 5, in a third gearshift clutch assembly 66. The third clutch K3, just like the gearshift clutches A, B, C, D, E, is implemented as a non-synchronized dog clutch.

The third gearshift clutch assembly 66 is arranged coaxially to the first axis A1 and, in fact, between the gear sets 42, 48.

The dual-clutch assembly 14 and the three gearshift clutch assemblies 40, 52, 66 are actuatable by four actuating units S1, S2, S3, S4.

One actuating unit S1 is utilized for actuating the dual-clutch assembly 14, the actuating unit S1 also engages the first clutch K1, engages the second clutch K2, or establishes a neutral position.

In a corresponding way, the first gearshift clutch assembly 40 is actuated by a fourth actuating unit S4. By the fourth actuating unit S4, either the gearshift clutch A is engaged, or the gearshift clutch C is engaged, or a neutral position is established.

In a corresponding way, the second gearshift clutch assembly 52 is actuated by a third actuating unit S3, in order to either engage the clutch D, or engage the clutch B, or establish a neutral position.

Finally, the third gearshift clutch assembly 66 is engaged by a second actuating unit S2, in order to either engage the third clutch K3, or engage the clutch E, or establish a neutral position.

In FIG. 2, a further example embodiment of a hybrid drive train 10′ is represented, which generally corresponds to the drive train 10 from FIG. 1 with respect to the configuration and mode of operation. Identical elements are therefore indicated by identical reference characters.

It is apparent that input power from the internal combustion engine is guided either via the first clutch K1 to the first sub-transmission 32 or via the second clutch K2 to the second sub-transmission 34. Input power of the first electric machine 56 is supplied directly into the first sub-transmission 32 or, via the first clutch K1, toward the internal combustion engine 12 (for example, in order to start the internal combustion engine 12).

Input power of the second electric machine 60 is introduced directly into the second sub-transmission 34 or, via the second clutch K2, to the internal combustion engine 12, for example, in order to start the internal combustion engine 12.

Moreover, it is apparent that the first sub-transmission 32 and the second sub-transmission 34 are connectable to each other via a third clutch K3, and so, for example, when the first clutch K1 is engaged, internal combustion engine-generated power flows via the third clutch K3 to the second sub-transmission 34.

In this case, the first electric machine 56 is switched to idle, and so the first electric machine 56 rotates in a nearly loss-free manner, or is operated as a generator or as an electric motor.

In a corresponding way, when the second clutch K2 is engaged, power of the internal combustion engine 12 is directed to the first sub-transmission 32 when the third clutch K3 is engaged.

Moreover, a serial operation is possible when, for example, purely electric motor-generated input power from the first electric machine 56 is guided via the first sub-transmission 32 to the output shaft 28. In this case, when the first and third clutches K1, K3 are disengaged, the second clutch K2 is engaged, in order to utilize input power of the internal combustion engine 12 to drive the second electric machine 60, in order to allow the second electric machine 60 to operate as a generator, which charges a battery (not represented in greater detail) of the drive train 10′. It is understood that all gearshift clutches of the second sub-transmission 34 are disengaged in this case.

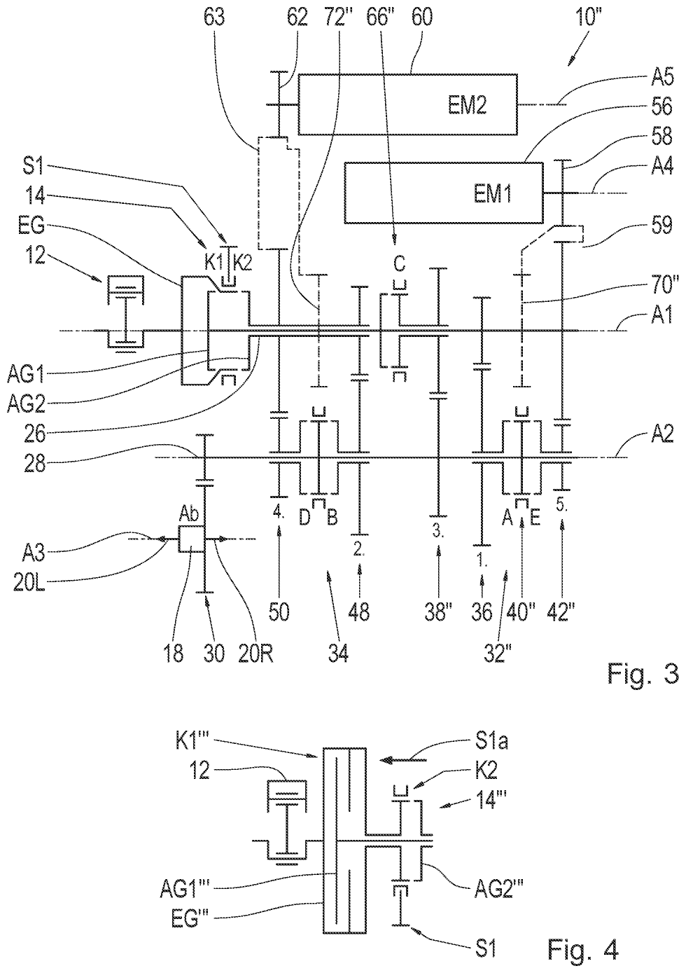

In FIG. 3, a further example embodiment of a hybrid drive train 10″ is represented, which generally corresponds to the drive train 10 from FIG. 1 with respect to configuration and mode of operation. Identical elements are therefore labeled with identical reference characters. In the following, essentially, the differences are explained.

It is apparent, on the one hand, that the gear sets for the third and fifth forward gear steps 3, 5 are interchanged in the first sub-transmission 32. Consequently, the second gear set 38″ for the third forward gear step 3 is arranged closer to the second axial end of the transmission arrangement 16 than the third gear set 42″ for the fifth forward gear step 5, which is arranged adjacent to the first axial end of the transmission arrangement 16.

As represented in FIG. 3, moreover, the first electric machine 56 and/or the second electric machine 60 do/does not necessarily need to be connected via a gear-step gear set to the particular associated input shaft 24, 26. Rather, it is also possible to fix a first gearwheel (first machine gearwheel) 70″ at the first output shaft 24, which is in engagement with the first pinion 58 directly or via a first intermediate gear 59.

In a corresponding way, a second gearwheel (second machine gearwheel) 72″ is fixed at the second output shaft 26, which is in engagement with the second pinion 62 directly or via a second intermediate gear 63.

Due to the first gearwheel 70″ and/or the second gearwheel 72″, one additional degree of freedom is implemented, which simplifies the implementation of the pre-ratio.

The first gearwheel 70″ is preferably situated in a plane with the first gearshift clutch assembly 40″, and so this implementation is possible in a length-neutral manner. In the same way, the second gearwheel 72″ is axially aligned with the second gearshift clutch assembly 52, and so the provision of the second gearwheel 72″ also does not result in a lengthening of the installation space.

In particular for the case in which the gearwheels 70″, 72″ are not provided, but rather a connection is to take place via the gear sets that are arranged at the axial ends of the transmission arrangement 16, the following advantage is achieved. This is the case because the first electric machine 56 is connected to the first input shaft 24 via the gear-step gear set 42″ that represents the highest ratio of the first sub-transmission 32, and so a larger ratio is implemented in the electric operation.

The latter-described example variant is considered to be particularly preferred.

The hybrid drive train 10″ from FIG. 3 also does not include a third clutch K3. The gearshift clutch assembly 66″ therefore exclusively includes, in the present case, the gearshift clutch C for engaging the second gear set 38″ for the third forward gear step 3.

In FIG. 4, an alternative example embodiment of a dual-clutch assembly 14′″ is shown, which is utilized in each of the above-described example drive trains alternatively to the dual-clutch assemblies 14 utilized there.

The dual-clutch assembly 14′″ includes a second clutch K2, which, similarly to the dual-clutch assembly 14, is an unsynchronized dog clutch and which is actuatable by an actuating unit S1.

Instead of the unsynchronized dog clutch K1, a first clutch K1′″ is provided in the dual-clutch assembly 14′″ in the form of a normally disengaged friction clutch, which is actuatable either by the same actuating unit S1 or by a separate actuating unit S1a and, in fact, independently of the actuating unit S1.

The first clutch K1′″ is a normally disengaged friction clutch and has the advantage that the first clutch K1′″ is also disengageable under load, for example, in the case of an emergency brake application. As a result, the internal combustion engine is also decoupleable in an emergency of this type.

The second clutch K2 is not utilized in this case (as will also be explained in the following) for establishing a power flow for forward gear steps of the transmission arrangement 16, but rather essentially for coupling the second electric machine 60 to the internal combustion engine 12.

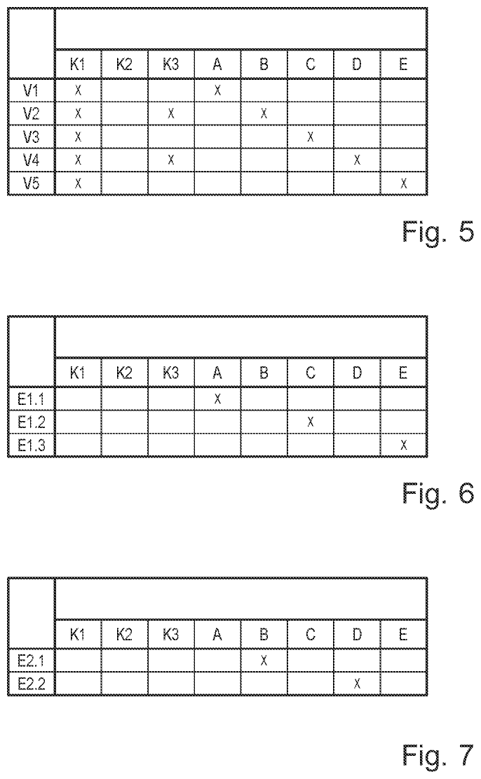

Different operations, which are establishable with the example hybrid drive train 10 from FIGS. 1 and 2, are explained with reference to FIGS. 5-7. Comparable operations are usable with the hybrid drive train 10″ from FIG. 3 and/or in connection with the dual-clutch assembly 14″ from FIG. 4.

FIG. 5 shows a gearshift table of the shift elements K1, K2, K3, A, B, C, D, E in a purely internal combustion engine-driven operation or in a hybrid operation, in which input power is made available by the internal combustion engine and, optionally, by the electric motors.

In all forward gear steps V1, V2, V3, V4, V5 establishable in this operation, the first clutch K1 is continuously engaged and the second clutch K2 of the dual-clutch assembly 14 is continuously disengaged. In the first forward gear step V1, the gearshift clutch A is engaged and all other gearshift clutches B, C, D, E are disengaged. The third clutch K3 is also disengaged. Consequently, power flows from the internal combustion engine via the first clutch K1 and the first input shaft 24 to the first gear set 36 and, from there, via the gearshift clutch A to the output shaft 28.

It is understood that a driving start from a standstill generally takes place purely by electric motors 56, 60 until a speed is reached, at which the internal combustion engine 12 is connected via the first clutch K1, i.e., at a speed that corresponds to a rotational speed above the idling speed of the internal combustion engine 12. Consequently, a driving start from a standstill takes place, for example, via the first electric machine 56 and the first gear set 36 for the first forward gear step V1. As soon as a speed has been reached that corresponds to the speed of the internal combustion engine 12, the first clutch K1 is engaged. The first clutch K1 remains engaged during the entire internal combustion engine-driven operation.

During the changeover from the first forward gear step V1 into the second forward gear step V2, initially the gearshift clutch B for the second forward gear step V2 is preliminarily engaged. This takes place, if necessary, with a synchronization by the second electric machine 60.

Thereafter, the gearshift clutch A for the first forward gear step V1 is disengaged, wherein the tractive force is supported by the second electric machine 60 and the already engaged gear set 48 for the second forward gear step V2. Thereafter, the third clutch K3 is engaged, wherein the synchronization necessary therefor takes place, on the one hand, by a rotational-speed adaptation of the internal combustion engine 12, but also by appropriate synchronization measures of the second electric machine 16. In the second forward gear step V2, power consequently flows from the internal combustion engine 12 via the first clutch K1, the first input shaft 24, the engaged third clutch K3, the second input shaft 26, and the gear set 48 for the second forward gear step V2, which is engaged by the gearshift clutch B, to the output shaft 28.

During the changeover into the third forward gear step V3, the third clutch K3 is disengaged, the tractive force is supported via the second electric machine 60 and, thereafter, the connecting gear step V3 is engaged in the first sub-transmission 32 by engaging the gearshift clutch C. The necessary synchronization takes place by the first electric machine 56.

Thereafter, the load is supported by the first electric machine 56 and the gearshift clutch B of the second forward gear step V2 is disengaged.

The further gear changes from the third and fourth gear steps V3, V4 and from the fourth and fifth gear steps V4, V5 result in a corresponding way. In both of the even forward gear steps V2, V4, the third gearshift clutch K3 is engaged. The second clutch K2 is always disengaged and the first clutch K1 is always engaged.

In FIG. 6, a purely electric motor-driven operation by the first electric machine is represented. In a first electric gear step E1.1, only the gearshift clutch A for the first forward gear step 1 is engaged. In a second electric forward gear step E1.2, only the gearshift clutch C is engaged. In a third electric-motor gear step E1.3, the gearshift clutch E is engaged.

In a corresponding way, FIG. 7 shows a purely electric motor-driven operation by the second electric machine 60. In a first gear step E2.1, only the gearshift clutch B is engaged. In a second electric gear step E2.2, only the gearshift clutch D is engaged.

In the purely electric operation according to FIGS. 6 and 7, purely electric powershifts (i.e., gear changes between forward gear steps without or with reduced interruption of tractive force) are possible. Here, an electric motor-driven operation is established exclusively, for example, between the gear steps E1.1, E1.2, E1.3 or exclusively between the gear steps E2.1, E2.2, and a gear change takes place while the other electric machine maintains the tractive force.

During a gear change, for example, from the forward gear step E1.1 into the forward gear step E1.2, the gearshift clutch B is engaged in the second sub-transmission and, consequently, the second electric machine 60 maintains the tractive force during the gear change in the first sub-transmission 32.

In the purely internal combustion engine-driven operation or hybrid operation (i.e., for the case in which internal combustion engine-generated power and, optionally, electric motor-generated power are guided to the output shaft), it is advantageous that the third clutch K3 is utilized for connecting the second input shaft 26 to the first input shaft 24 and, consequently, always supplying internal combustion engine-generated power into the transmission arrangement 16 via the first input shaft 24. Consequently, the first electric machine 56 associated with the first sub-transmission 32 is always rotationally fixed to the internal combustion engine 12 during this operation. As a result, it is possible to establish load-point displacements at the internal combustion engine 12 and the first electric machine 56 provides assistance during the closed-loop control of the rotational speed when a synchronization process is to take place. In other words, since the first clutch K1 always remains engaged, the first electric machine 56 assists the internal combustion engine 12 during synchronization.

In order to integrate the third clutch K3, which is necessary therefor, into the transmission arrangement as efficiently as possible, the third clutch K3 is accommodated in the third gearshift clutch assembly 66. Since the third clutch K3 is therefore integrated with a gearshift clutch into a gearshift clutch assembly that is associated with that sub-transmission, the associated first clutch K1—of the dual-clutch assembly 14—of which is always engaged in the internal combustion engine-driven or hybrid operation, the internal combustion engine utilizes all gear steps of the transmission.

The second clutch K2 is engaged, however, when a so-called “serial operation” is established. Here, the first clutch K1 is disengaged. Via the first sub-transmission 32 and the first electric machine 56, a purely electric motor-driven operation is established in a gear step, for example, in the first forward gear step 1. The internal combustion engine 12 drives the second electric machine 60 via the engaged second clutch K2 and operates it as a generator, and so the power withdrawn from a vehicle battery by the first electric machine 56 in this purely electric operation is simultaneously resupplied, at least partially, via the second electric machine 60.

A serial operation of this type is also possible in reverse when travel takes place purely electrically by the second electric machine 60 and the internal combustion engine 12 drives the first electric machine 56. In the latter case, the first clutch K1 is engaged and the second clutch K2 is disengaged.

The serial operation is utilized, in particular, in a so-called “crawling mode,” in which the vehicle speed is lower than a minimum speed that is establishable by the internal combustion engine 12.

The sub-transmission 32 that is associated with the first clutch K1, which is always engaged in the internal combustion engine-driven mode, preferably also includes the highest forward gear step of the transmission arrangement 16. As a result, when the third clutch K3 is disengaged, the second electric machine 60 is practically decoupled, in order to avoid drag losses. In addition, the first electric machine 56 remains coupled, in order to supply the main power circuit with electrical energy (operation as a generator), or in order to establish a boost operation (operation as a motor).

During a gear shift from a forward gear step of the first sub-transmission 32 into a forward gear step of the second sub-transmission 34, the desired gear step is initially engaged in the second sub-transmission by engaging the associated gearshift clutch (D or B). This takes place with the aid of a synchronization by the second electric machine 60, wherein the second electric machine 60 switches over, in a load-free manner, into this target gear step in the second sub-transmission 34. Thereafter, the second electric machine 60 supports the tractive force during the gear shift via the already engaged target gear step. During the gear shift, initially the gearshift clutch of the first sub-transmission 32, which is associated with the starting or source gear step, disengages and, thereafter, the third clutch K3 is engaged, wherein the internal combustion engine 12 and the first electric machine 56 interact during the synchronization.

During a gear shift from the second sub-transmission 34 into a gear step of the first sub-transmission 32, the second electric machine 60 initially supports the tractive force in the source gear step or the actual gear during the gear shift. During the gear shift, the third clutch K3 is initially disengaged and one of the shift elements A, C, E engages, wherein the internal combustion engine 12 and the first electric machine 56 interact during the necessary synchronization. After the disengagement of the third clutch K3 and the load transfer on the first sub-transmission 32, the output gear step (actual gear step) in the second sub-transmission 34 is disengaged.

It is understood that a stationary charging also takes place with the hybrid drive train when the vehicle is at a standstill. For example, the first clutch K1 is engaged and input power of the internal combustion engine 12 is supplied via the first input shaft 24 into the first electric machine 56. The second clutch K2 remains disengaged and the gearshift clutches A, C, E of the first sub-transmission 32 also remain disengaged. Therefore, the first sub-transmission 32 remains in neutral. In this condition, as mentioned, a stationary charging takes place, but a start of the internal combustion engine 12 by the first electric machine 56 also takes place.

In general, it is also conceivable to engage both clutches K1, K2 or to engage the first clutch K1 and the third clutch K3, in order to allow a charging process to take place by the first electric machine 56 and also by the second electric machine 60. In this case, the internal combustion engine 12 drives both electric machines and the electric machines 56, 60 both operate as generators, in order to charge a vehicle battery.

In the hybrid drive train 10″ from FIG. 3, the electric motor-driven operations are established precisely in the same way as described in FIGS. 6 and 7.

With regard to the internal combustion engine-driven operation and with regard to the hybrid operation, however, due to the absence of the third clutch K3 in the hybrid drive train 10″, a switch generally takes place back and forth between the first clutches K1, K2, in order to switch the power flow from one sub-transmission onto the other sub-transmission when a changeover is to take place from one gear step into a directly following connecting gear step. The first clutches K1, K2 are dog clutches in this case, or are friction clutches or formed by a dual-clutch assembly 14′″, as shown in FIG. 4.

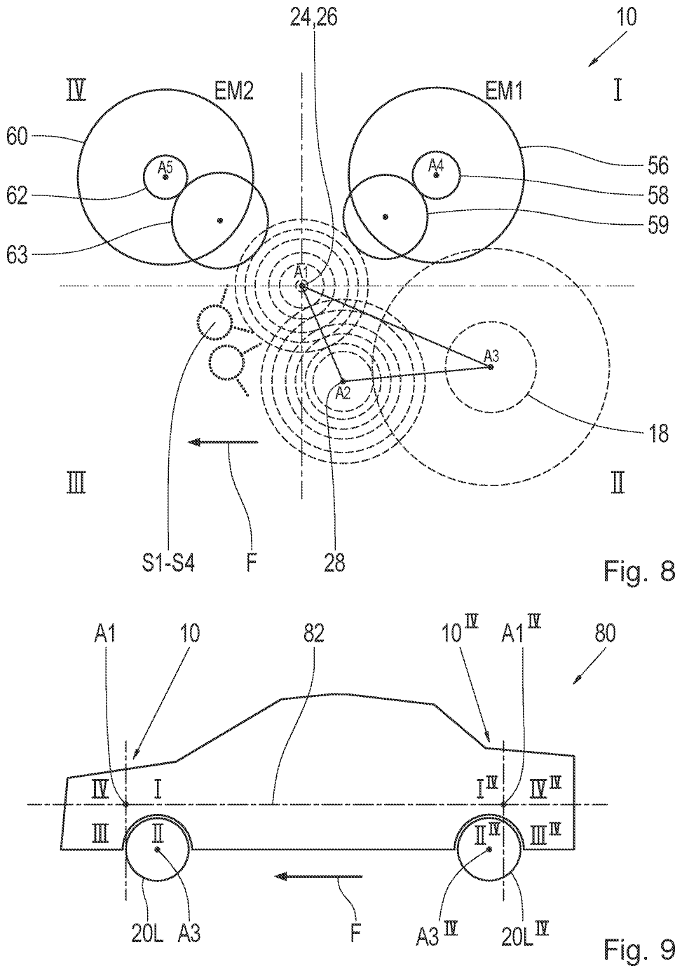

In FIG. 8, an axial view of a drive train 10 is represented, which generally corresponds to the drive trains 10, 10″ from FIG. 1 or FIG. 3 with respect to configuration and mode of operation.

It is apparent that the first axis A1 of the input shafts 24, 26 is situated in a center of a coordinate system having four quadrants I, II, III, and IV.

Since the drive train 10, 10″ is generally installed transversely in the direction of travel of a motor vehicle, a preferred forward direction of travel at F is also represented in FIG. 8.

Of the four quadrants I-IV, a first quadrant I is situated above the input shaft arrangement 24, 26 and on a first longitudinal side (at the rear) of the input shaft arrangement 24, 26. A second quadrant II is situated below the input shaft arrangement and on the first longitudinal side. A third quadrant III is situated below the input shaft arrangement 24, 26 and is situated on a second longitudinal side (at the front) of the input shaft arrangement 24, 26. A fourth quadrant IV is situated above the input shaft arrangement and on the second longitudinal side of the input shaft arrangement.

The second axis A2 of the countershaft 28 is situated in the second quadrant II. The third axis A3 of the power distribution unit 18 is also situated in the second quadrant II. The second axis A2 is arranged closer to the third quadrant III than the third axis A3.

Actuating units S1-S4 are arranged in the third quadrant III.

The first electric machine 56 is completely arranged, with its fourth axis A4, in the first quadrant I. The second electric machine 60 is completely arranged, with its fifth axis A5, in the fourth quadrant IV.

The intermediate gear 59 is arranged completely in the first quadrant I. The intermediate gear 63 is arranged completely in the fourth quadrant IV.

The power distribution unit is arranged predominantly in the second quadrant II, although the power distribution unit can also extend into the first quadrant I.

The countershaft 28 with the gearwheels arranged thereon is arranged predominantly in the second quadrant II, although the countershaft 28 can also extend, with a few gearwheels, into the third quadrant III.

FIG. 9 shows how the hybrid drive train 10 is installable either in the front or in the rear of a motor vehicle 80, the longitudinal axis 82 of which is aligned with the preferred forward direction of travel F.

The longitudinal axis 82 of the motor vehicle 80 is preferably aligned in parallel to the axis of the above-described coordinate system that separates the quadrants I, IV situated at the top from the quadrants II, III situated at the bottom.

The third axis A3 is preferably situated coaxially to driven wheels.

In FIG. 9, the first axis A1 for a drive train 10 is arranged in the area of the front of the motor vehicle 80. In FIG. 9, alternatively, a first axis A1 for a drive train 10 is arranged in the area of a rear of the motor vehicle 80.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

10 hybrid drive train
12 internal combustion engine
14 dual-clutch assembly
16 hybrid transmission arrangement
18 power distribution unit
20 driven wheels
22 control device
24 first input shaft
26 second input shaft
28 output shaft
30 output gear set
32 first sub-transmission
34 second sub-transmission
36 gear set (1)
38 gear set (3)
40 first gearshift clutch assembly
42 gear set (5)
48 gear set (2)
50 gear set (4)
52 second gearshift clutch assembly
56 first electric machine
58 first pinion (first machine pinion)
59 first intermediate gear
60 second electric machine
62 second pinion (second machine pinion)
63 second intermediate gear
66 third gearshift clutch assembly
70 first gearwheel (first machine gearwheel)
72 second gearwheel (second machine gearwheel)
80 motor vehicle
82 longitudinal axis of motor vehicle
A1-A5 axes
A-E gearshift clutches for gear steps
K1, K2 clutches of dual-clutch assembly
EG input element
AG1 first output element
AG2 second output element
K3 third clutch (bridge clutch)
S1-S4 actuating units
P parking interlock gear

1-15: (canceled)

16. A hybrid transmission assembly (16) for a motor vehicle powertrain (10), comprising:
an input shaft arrangement (24, 26) including a first input shaft (24) of a first sub-transmission (32) and a second input shaft (26) of a second sub-transmission (34);
a first electric machine (56) connected to the first input shaft (24) and axially parallel to the first input shaft (24); and
a second electric machine (60) connected to the second input shaft (26) and axially parallel to the second input shaft (26),
wherein the input shaft arrangement (24, 26), viewed axially, is in a center of four quadrants (I, II, III, IV), a first quadrant (I) of the four quadrants being above the input shaft arrangement (24, 26) and on a first longitudinal side of the input shaft arrangement (24, 26), a second quadrant (II) of the four quadrants being below the input shaft arrangement (24, 26) and on the first longitudinal side of the input shaft arrangement (24, 26), a third quadrant (III) of the four quadrants being below the input shaft arrangement (24, 26) and on a second longitudinal side of the input shaft arrangement (24, 26), and a fourth quadrant (IV) of the four quadrants being above the input shaft arrangement (24, 26) and on the second longitudinal side of the input shaft arrangement (24, 26), and
wherein one or both of an axis (A4) of the first electric machine (56) is in the first quadrant (I) and an axis (A5) of the second electric machine (60) is in the fourth quadrant (IV).

17. The hybrid transmission assembly of claim 16, further comprising a countershaft (28), a power distribution unit (18), and an output gear set (30),
wherein the first input shaft (24) and the second input shaft (26) are connected to the countershaft (28) via at least one engageable gear set (36, 38 42; 48, 50), and
wherein the countershaft (28) is connected to the power distribution unit (18) via the output gear set (30).

18. The hybrid transmission assembly of claim 17, wherein one or more of:
an axis (A3) of the power distribution unit (18) is in the second quadrant (II);
an axis (A2) of the countershaft (28) is in the second quadrant (II); and
the axis (A2) of the countershaft (28) is closer to the third quadrant (III) than the axis (A3) of the power distribution unit (18).

19. The hybrid transmission assembly of claim 16, further comprising actuating units (S1-S4) in the third quadrant (III), the actuating units being axially displaceable for one or more of engaging engageable gear sets (36, 38 42; 48, 50), actuating a dual-clutch assembly (14) associated with the hybrid transmission assembly (16), and actuating a third clutch (K3).

20. The hybrid transmission assembly of claim 16, wherein one or both of:
the first electric machine (56) is connected to the first input shaft (24) via an engageable gear set (38; 42″) of the first sub-transmission (32); and
the second electric machine (60) is connected to the second input shaft (26) via an engageable gear set (50) of the second sub-transmission (34).

21. The hybrid transmission assembly of claim 20, wherein one or both of:
the engageable gear set (42″) of the first sub-transmission (32) is associated with a highest gear step (5) of the first sub-transmission (32); and
the engageable gear set (50) of the second sub-transmission (34) is associated with a highest gear step (4) of the second sub-transmission (34).

22. The hybrid transmission assembly of claim 20, wherein one or both of:
the engageable gear set (38; 42″) of the first sub-transmission (32) is at a first axial end of the hybrid transmission assembly (16); and
the engageable gear set (50) of the second sub-transmission (34) is at a second axial end of the hybrid transmission assembly (16).

23. The hybrid transmission assembly of claim 16, wherein one or both of:
the first electric machine (56) is connected to a first gearwheel (70) at the first input shaft (24) via a first intermediate gear (59); and
the second electric machine (60) is connected to a second gearwheel (72) at the second input shaft (26) via a second intermediate gear (63).

24. The hybrid transmission assembly of claim 16, wherein the first sub-transmission (32) has three gear sets (36, 38, 42), each of the three gear sets (36, 38, 42) of the first sub-transmission (32) being associated with a respective, odd forward gear step, and
wherein the second sub-transmission (34) has two or three gear sets (48, 50), each of the two or three gear sets (48, 50) of the second sub-transmission being associated with a respective, even forward gear step.

25. The hybrid transmission assembly of claim 16, wherein the first electric machine (56) and the second electric machine (60) are identical.

26. The hybrid transmission assembly of claim 16, further comprising:
a third clutch (K3), the first sub-transmission (32) being connectable to the second sub-transmission (34) via the third clutch (K3); and
a gearshift clutch (E; C), a gear set (42; 38″) of one of the first and second sub-transmissions (32) being engageable by the gearshift clutch (E; C),
wherein the third clutch (K3) and the gearshift clutch (E; C) form a gearshift clutch assembly (66; 66″).

27. A hybrid powertrain, comprising:
a dual-clutch assembly (14) including a first clutch (K1) and a second clutch (K2), the first and second clutches (K1, K2) having a shared input element (EG) connectable to an internal combustion engine (12), the first clutch (K1) including a first output element (AG1), and the second clutch (K2) including a second output element (AG2); and
the hybrid transmission assembly of claim 16,
wherein the first input shaft (24) is connected to the first output element (AG1), and
wherein the second input shaft (26) is connected to the second output element (AG2).

28. The hybrid powertrain of claim 27, wherein one or more of the first clutch (K1), the second clutch (K2), a third clutch (K3), and/or at least one gearshift clutch (A, B, C, D, E) is a dog clutch.

29. The hybrid powertrain of claim 27, wherein the first clutch (K1) is a friction clutch, and
wherein the second clutch (K2) is a form-locking dog clutch.

30. A motor vehicle (80), comprising the hybrid transmission assembly of claim 16,
wherein the hybrid transmission assembly (16) is aligned transversely to a longitudinal axis (82) of the motor vehicle (80) and is installed in the motor vehicle (80) at a front end of the motor vehicle to drive front wheels of the motor vehicle or at a rear end of the motor vehicle to drive rear wheels of the motor vehicle.
